(19) United States
(12) Patent Application Publication
(10) Pub. No.: US 2007/0001016 A1
(43) Pub. Date: Jan. 4, 2007

(54) Transaction card and case

(76) Inventors: Burnett Hunter JR., Briarcliff Manor, NY (US); Cheri Lynne Dorr, New York, NY (US); Mihai Badulescu, New York, NY (US)

Correspondence Address: BAKER & BOTTS, 30 ROCKEFELLER PLAZA, 44TH FLOOR, NEW YORK, NY, 10112-4498, US

(21) Appl. No.: 11/102,020

(22) Filed: Apr. 8, 2005

Related U.S. Application Data
(60) Provisional application No. 60/560,438, filed on Apr. 8, 2004.

(51) Int. Cl. G06K 19/00; G06K 7/00; G06K 19/06

(52) U.S. Cl. 235/487; 235/492; 235/493; 235/486

(57) ABSTRACT

A transaction card and case with a rotatable member in the case. The card is releasably attached to the rotatable member. The card can be removed from the case by exerting a force on the card in a direction away from the case. The case can lock the card in an open position for easily using the card. The case can also lock the card in a closed position for storage.

### CROSS REFERENCE TO RELATED APPLICATIONS

This application claims priority based on U.S. Provisional Patent Application entitled “TRANSACTION CARD AND CASE,” Ser. No. 60/560,438, which was filed on Apr. 8, 2004. This application is also related to the following U.S. Design Patent Applications: “CARDHOLDER WITH CARD,” Ser. No. 29/203,021, which was filed on Apr. 8, 2004; “CARD,” Ser. No. 29/203,020, which was filed on Apr. 8, 2004; and “CARD WITH NOTCH,” Ser. No. 29/203,022, which was filed on Apr. 8, 2004.

### TECHNICAL FIELD OF THE INVENTION

The present invention relates generally to transaction cards and cardholders. More specifically, the invention relates to an improved transaction card and case.

### BACKGROUND OF THE INVENTION

Transaction cards are widely used in the financial industry and other industries. They are provided to persons or entities (usually referred to as cardholders) for performing financial and other types of transactions. Similar types of cards may be used for identification, for example, in connection with security systems. There is a need for a transaction card with a case to provide a protected storage area for the transaction card when the card is not being used. There is also a need for a transaction card with a case that can lock when the card is pivoted from the case to assist in inserting the card into a terminal or card reader. There is also a need for the card to be easily replaced without having to disassemble the case.

### SUMMARY OF THE INVENTION

Accordingly, the present invention includes a transaction card, capable for use with a transaction device, and a card case having a hinge recess therein. The system also includes a rotatable member interfaced with the hinge recess and capable of being rotated from an unlocked position to a temporarily locked position. The card has a notch and is attached at the notch to the rotatable member for movement between the unlocked and temporary locked positions, such that the card is adapted to be held within the card case for use with the transaction device in the temporarily locked position. The card may also be releasably attached at the notch to the rotatable member.

Preferably, the transaction card has a data region which is exposed when the card is in the temporarily locked position and being used with the transaction device.

### DESCRIPTION OF THE DRAWINGS

For a more complete understanding of the present invention, and the advantages thereof, reference may be made to the following description of exemplary embodiments, taken in conjunction with the accompanying drawings, in which:

FIG. 1 is a top view of one embodiment of the present invention;

FIG. 2 is a top view of one embodiment of the present invention;

FIG. 3 is a bottom view of one embodiment for use in the present invention;

FIG. 4 is a side view of one embodiment of the present invention;

FIG. 5 is a top view of one embodiment of a card for use in the present invention;

FIG. 6 is a top view of one embodiment of a card case portion for use in the present invention;

FIG. 7 is a bottom view of one embodiment of a card case portion for use in the present invention;

FIG. 8 is a top view of one embodiment of a recess for use in the present invention;

FIG. 9 is a side cross-sectional view of one embodiment of a recess for use in the present invention;

FIG. 10 is a top view of one embodiment of a card case portion for use in the present invention;

FIG. 11 is a bottom view of one embodiment of a card case portion for use in the present invention;

FIG. 12 is a side cross-sectional view of one embodiment of a recess for use in the present invention;

FIG. 13 is a top view of one embodiment of a rotatable member for use in the present invention;

FIG. 14 is a side view of one embodiment of a rotatable member for use in the present invention;

FIG. 15 is a side view of one embodiment of a rotatable member for use in the present invention;

FIG. 16 is a bottom view of one embodiment of a rotatable member for use in the present invention;

FIG. 17 is a front view of one embodiment of a hook for use in the present invention;

FIG. 18 is a top view of one embodiment of a logo disc for use in the present invention; and

FIG. 19 is a side view of one embodiment of a logo disc for use in the present invention.

### DESCRIPTION OF THE EMBODIMENTS

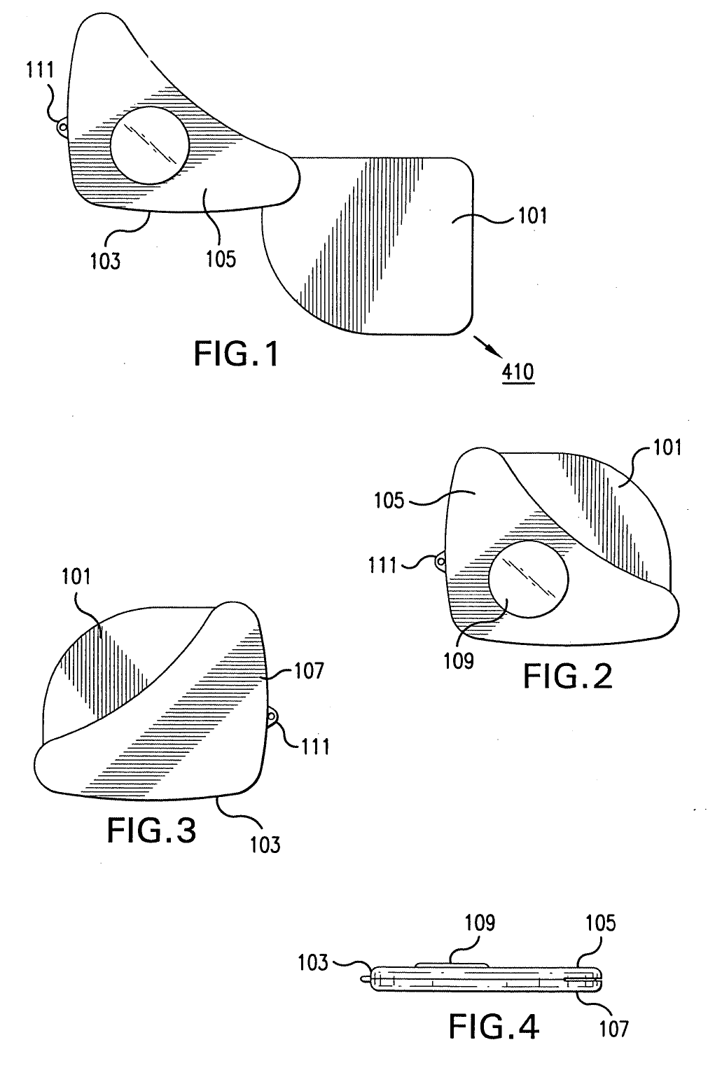

One embodiment of the present invention is shown in FIGS. 1-4. The card is in a retracted position in FIGS. 2-4 and in an opened position in FIG. 1. Providing a temporarily locked opened position is useful when a cardholder or retail agent desires to insert the card into a transaction terminal or card reader, such as when using the card to make a purchase. The locked position makes the card and case more stable, easier to grip, and easier to insert into a card reader than if no locked position existed. Although the card case (103) shown in FIGS. 1-4 includes a hook (111), the present invention does not require a hook.

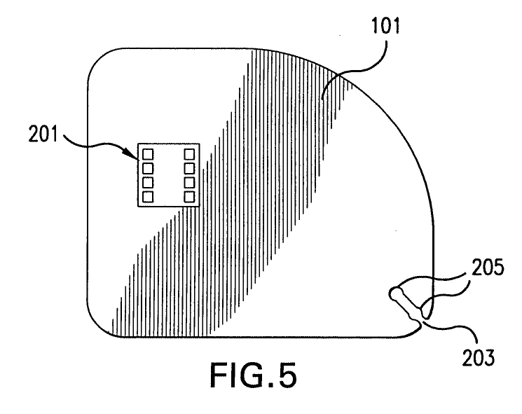

One embodiment of a card of the present invention is illustrated in FIG. 5. Although the card (101) shown in FIG. 5 includes a smart-card contact pad (201), the card may include a data region containing a magnetic stripe and/or a contactless antenna in addition to, or in lieu of, the smart card contact pad (201). Other devices, such as a processor, memory, operating system, application software, and/or firmware may also be installed in the card, but are not shown in the figures for simplicity.

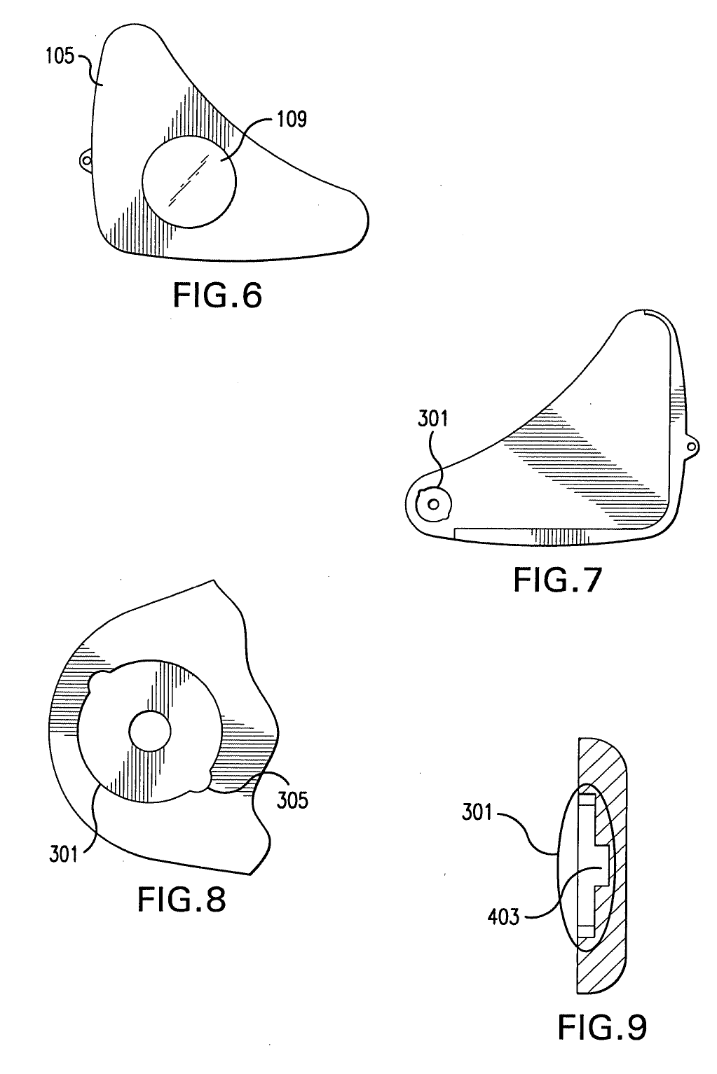

Several embodiments of a card case with a recess are shown in FIGS. 6-12. FIGS. 6-9 show an embodiment of a case portion (105). The case portion (105) includes a hinge recess (301) and a receptacle (403) as shown in FIGS. 7-9. A rotatable member fits inside the hinge recess (301) as discussed further herein. The hinge recess (301), in one embodiment, may have one or more notches (305). The case portion (105) may include a logo portion (109) for displaying a logo on the case.

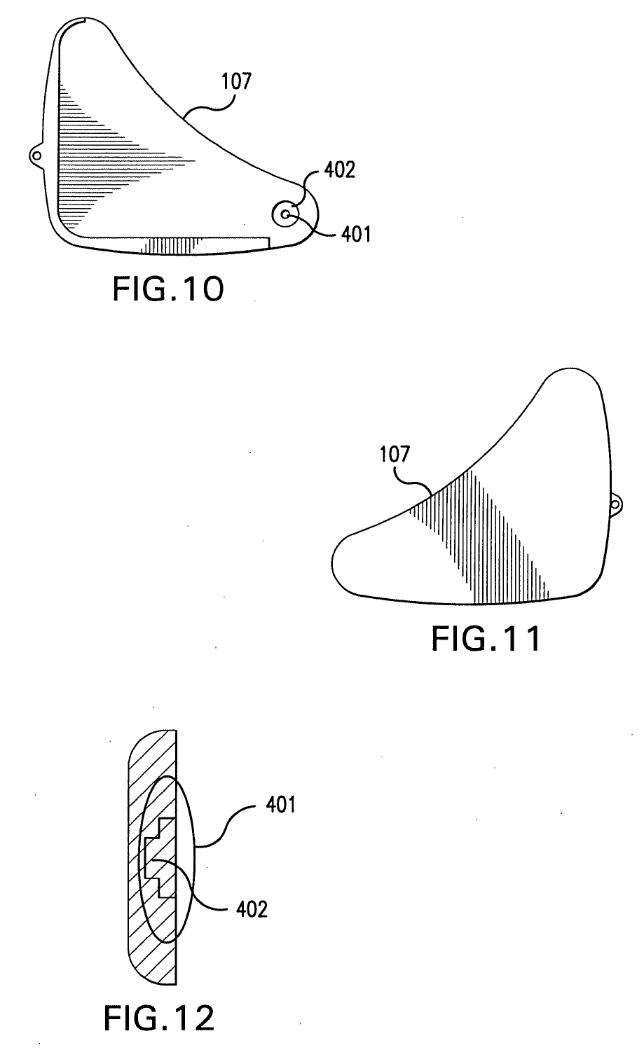

FIGS. 10-12 show an embodiment of a second case portion (107). The second case portion (107) has a recess (401) including a receptacle (402) for holding the rotatable member and card inside the case (103), and in between the case portions (105, 107).

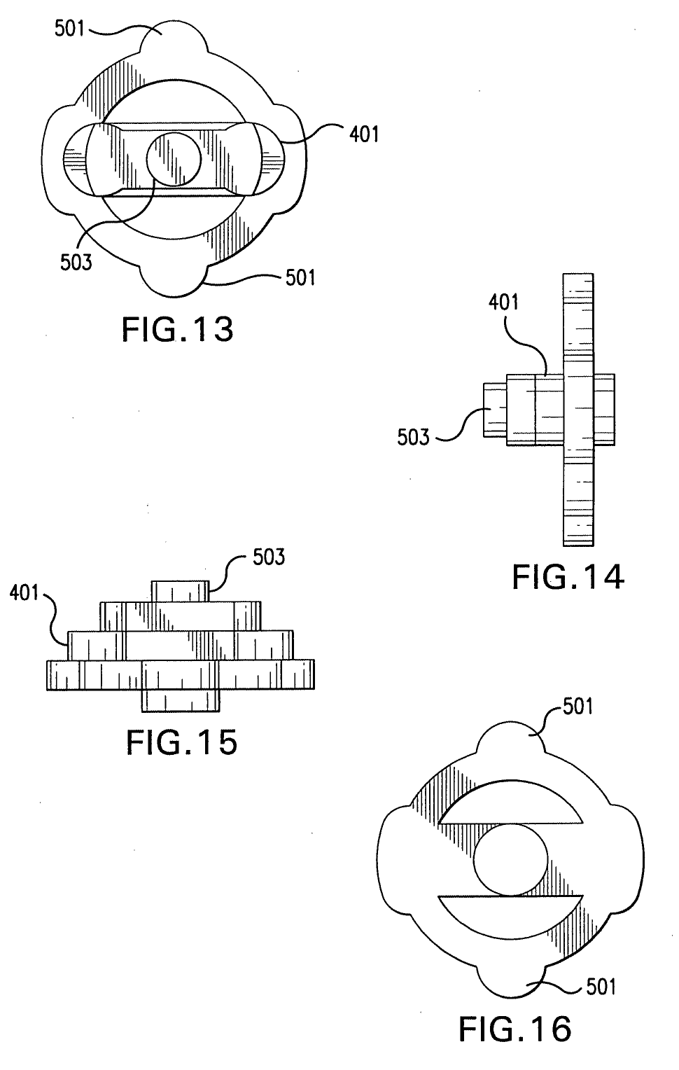

One embodiment of a rotatable member is shown in FIGS. 13-16 in various views. The rotatable member, as shown in FIGS. 13-16, of the invention may also include one or more secondary projections (401) to receive the card within the case in a releasable fashion. For instance, the card may include a notch (203) shown in FIG. 5 including one or more notch portions (205) along the notch that have a notch-opening width that differs from the width of the remainder of the notch (203). This notch (203) on the card may grip onto the secondary projections (401) of the rotatable member, shown in FIGS. 13-15, to secure the card within the case. The mechanical force exerted by the card on the secondary projections (401) (or vice versa) should be sufficient to hold the card onto the member under normal use, including moving the card from the retracted position within the case, to the opened position where the card is mostly or entirely exposed from the case. Further, the card should remain secured onto the member during insertion and removal of the card from a card reader or other point of sale or transaction terminal.

However, the card should be able to be released from the rotatable member if a sufficient tension force is applied to the card in a direction away from the case. For example, when the card is in the opened position, as shown in FIG. 1, a sufficiently-large tension force applied in the direction away from the card case (410) could cause the card (101) to release its grip on the rotatable member and become completely separated from the rotatable member and case (103). In one exemplary embodiment, the tension force required to remove the card from the rotatable member should be sufficiently small that most cardholders would be able to remove the card once it has expired or become damaged without any special equipment or tools and without disassembling the case.

The rotatable member is generally circular when viewed from a direction perpendicular to its axis of rotation. The rotatable member may include a translational inhibitor projection (503) on both sides of the member to interface into a receptacle (402, 403) in the recess (301, 401) in the case, shown in FIGS. 9 and 12, providing mechanical stability and minimizing translational movement of the rotatable member within the case.

The rotatable member may also include one or more rotational inhibitor projections (501) along the outside circumference of the member, as shown in FIGS. 13-16. A recess in the case within which the rotatable member fits is also generally circular, but contains one or more notches (305) in the circumference of the recess, as shown in FIGS. 7-9. The rotatable member may temporarily lock into a fixed position within the recess when a projection (501) of the rotatable member encounters a notch (305) in the circumference of the recess.

In one embodiment, shown in FIGS. 13 and 16, the rotatable member includes two projections (501), separated from each other by 180 degrees. The member may be released from the fixed position by exerting a sufficient torque on the member to cause the projection or projections of the member to exit the notch or notches in the hinge recess. The torque may be applied to the rotatable member by gripping and exerting a rotational force on the card relative to the case (and/or vice versa), which will impart the torque onto the rotatable member attached to the card.

Accordingly, in one embodiment there may be two notches (305) in the circumference of the recess, allowing the rotatable member to take two fixed positions, one retracted or closed position where one or more relatively delicate card component(s) such as a smart-card contact pad, magnetic stripe, or antenna is/are inside the card case, and an opened position, where one or more certain relatively delicate card component(s) is/are exposed from the card case.

When assembled, one or more notch portions (205) of the notch (203) on the card (101), as shown in FIG. 5, grips onto one or more secondary projections (401) of the rotatable member, as shown in FIG. 12-15, which itself may rotate within a hinge recess (301, 401) in the card case, as shown in FIGS. 7 and 10.

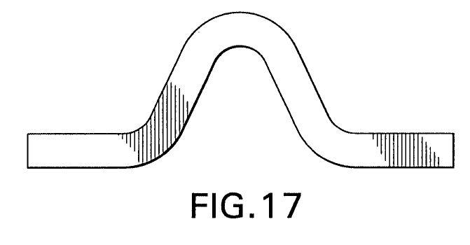

In one exemplary embodiment of the present invention shown in FIG. 1, the card case includes an optional hook (111). An expanded view of the hook is shown in FIG. 17. A hook may be used to attach the card case to a keychain, for example. In other embodiments of the present invention, the card case does not include a hook.

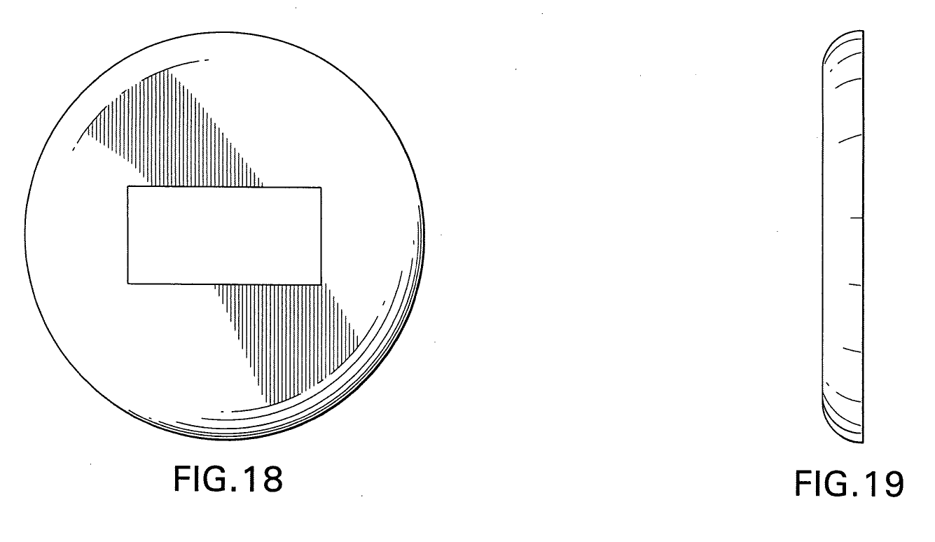

FIGS. 18 and 19 show one embodiment of a logo disc of the present invention. The logo disc is optional. The logo disc may or may not be attached to the card case. If the logo disc is attached to the card case, it may be attached on a logo portion (109) of the card case as shown in FIG. 2.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A system combining a transaction card, capable for use with a transaction device, with a card case having a recess, comprising:
a rotatable member interfaced with said recess and capable of being rotated from an unlocked position to a first temporarily locked position;
said card having a notch and attached at said notch to said rotatable member for movement between said unlocked position and said first temporarily locked position, such that said card is adapted to be held within said card case for use with said transaction device in said first temporarily locked position.

2. The system of claim 1, wherein said card is releasably attached at said notch to said rotatable member.

3. The system of claim 2, wherein transaction card includes a card data region, and wherein said rotatable member is capable of being rotated from an unlocked position to a second temporarily locked position, whereby said card data region is at least substantially within said card case when said rotatable member is in said second temporarily locked position.

4. A transaction card and cardholder comprising:
a card case having recess therein, wherein said recess has at least one notch and at least one receptacle therein;
a rotatable member having at least one translational inhibitor projection for interfacing with said at least one receptacle, wherein said rotatable member is held in said recess and capable of rotation therein;
said rotatable member further having at least one rotational inhibitor projection for releasably interfacing with said at least one notch, thereby temporarily locking in a first position, and capable of being rotated into at least a second position, and further having at least one secondary projection; and
a card having data region thereon, and further having a card notch with at least one card notch portion for interfacing with said at least one secondary projection, thereby being releasably attached to said rotatable member;
whereby said data region is at least substantially outside said card case when said rotatable member is in said first position and said data region is at least substantially inside said card case when said rotatable member is in said second position.

5. The transaction card and case of claim 4 wherein said recess has at least two notches therein and wherein said at least one rotational inhibitor projection is capable of releasably interfacing with said at least two notches, forming said first position and said second position, respectively.

6. The transaction card and case of claim 5 wherein said card remains attached to said rotatable member when said rotatable member is in said first position and said second position.

7. The transaction card and case of claim 4 wherein said card is capable of being detached from said rotatable member and said card case by exerting a force on said card in a direction away from said rotatable member when said rotatable member is in said first position.

8. The transaction card and case of claim 4 wherein said data region includes a smart-card contact pad.

9. The transaction card and case of claim 4, wherein said data region includes a magnetic stripe.

10. The transaction card and case of claim 4 wherein said card case includes a hook.

11. The transaction card and case of claim 4 wherein the card case has a logo portion for receiving a logo.

12. A method for distributing replacement transaction cards comprising:
providing a card case to a cardholder, said card case comprising:
a recess, wherein said recess has at least one notch and at least one receptacle therein;
a rotatable member having at least one translational inhibitor projection for interfacing with said at least one receptacle, wherein said rotatable member is held in said recess and capable of rotation therein;
said rotatable member further having at least one rotational inhibitor projection for releasably interfacing with said at least one notch in a first position and capable of being rotated into at least a second position, and further having at least one secondary projection;
subsequent to said providing a card case, providing a replacement transaction card to said cardholder, said replacement transaction card comprising a card notch with at least one card notch portion for interfacing with said at least one secondary projection;
rotating said rotatable member into said first position;
aligning said card notch with said at least one secondary projection when said rotatable member is in said first position; and
subsequent to said aligning, applying force to said replacement card in a direction toward said rotatable member, thereby releasably attaching said replacement card to said rotatable member by causing said at least one notch portion to engage said at least one secondary projection.
